(19) United States
(12) Patent Application Publication
(10) Pub. No.: US 2018/0272891 A1
(43) Pub. Date: Sep. 27, 2018

(54) MODIFYING PERFORMANCE OF A POWERED VEHICLE

(71) Applicant: Inboard Technology, Inc., Soquel, CA (US)

(72) Inventor: Theodore Cerboneschi, San Francisco, CA (US)

(21) Appl. No.: 15/935,890

(22) Filed: Mar. 26, 2018

Related U.S. Application Data
(60) Provisional application No. 62/476,838, filed on Mar. 26, 2017.

(51) Int. Cl. B60L 15/00; B60Q 9/00; G01S 17/93

(52) U.S. Cl. CPC B60L 15/00; B60Q 9/00; A63C 17/12; B60Y 2400/301; B60Y 2400/3015; G01S 17/936

(57) ABSTRACT

A powered skateboard having a powered wheel. The performance of the powered wheel can be modified based on one or more signals from one or more sensors on the powered vehicle and/or on a user of the powered vehicle.

### CROSS-REFERENCE TO RELATED APPLICATIONS

This application claims priority to and the benefit of U.S. Provisional Patent Application No. 62/476,838, filed on Mar. 26, 2017, entitled “Modifying Performance of a Powered Vehicle,” the disclosure of which is incorporated herein in its entirety for all purposes.

### TECHNICAL FIELD

The subject matter described herein relates to modifying the performance of a powered vehicle in response to sensor readings and in particular sensor readings associated with actions by other users of other powered vehicles and/or sensor readings associated with a virtual reality framework for use with powered skateboards.

### BACKGROUND

Skateboards typically include an elongated board, sometimes referred to as a deck, having an upper surface and a lower surface. The upper surface typically support the feet of a rider of the skateboard and the lower surface typically have two trucks attached to the deck disposed toward either end of the deck. The upper surface may support the rider who is sitting on the skateboard. The trucks typically include one or more axles. Wheels, typically one on either side of the truck, attach to the axles. The trucks typically provide several degrees of freedom to the wheels relative to the skateboard deck, allowing the wheels to roll over uneven ground and facilitate turning of the skateboard by the rider.

Skateboards typically require the rider to provide the propelling force to move the skateboard, usually by the rider having one foot on the deck of the skateboard and another pushing off from the ground.

Some skateboards have been developed that include a power source. The power source may be a gasoline powered engine. The power source may be an electrically-powered motor. Typically, such power sources are appended to the underside of the skateboard deck or rest on top of the skateboard deck. These power source is typically separate from the wheels of the skateboard and connected to the wheels by gears, chain or pulley. Such power systems can adversely affect the distribution of mass and are also aesthetically displeasing.

### SUMMARY

In one aspect, a powered vehicle may include a powered skateboard may comprise a skateboard deck. The skateboard deck may comprise a bottom portion. The bottom portion may have truck mounting portions configured to facilitate engagement with one or more skateboard trucks. The skateboard deck may comprise a top portion. The top portion may have an upper surface. The upper surface may be configured to support a rider of the powered skateboard. The skateboard deck may have a cavity. The cavity may be disposed between the bottom portion and the top portion of the skateboard deck. The cavity may be adapted to store one or more components of the powered skateboard.

A controller can be disposed within the cavity. The controller can be configured to control the powered wheel. The controller can be configured to modify the performance of the powered wheel in response to signals received at the controller from one or more sensors. The signals received from the sensors can be associated with events occurring in a game played between multiple users of powered vehicles. The signals received from sensors can be associated with events occurring within a virtual environment associated with one or more computing devices associated with the powered vehicle.

The details of one or more variations of the subject matter described herein are set forth in the accompanying drawings and the description below. Other features and advantages of the subject matter described herein will be apparent from the description and drawings, and from the claims. Certain features of the currently disclosed subject matter are described for illustrative purposes only and it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings:

FIG. 1 is a side view of various elements of the skateboard, having one or more features consistent with implementations of the current subject matter;

FIG. 2A is an exploded perspective view of a powered wheel, having one or more features consistent with implementations of the current subject matter;

FIG. 2B is an exploded side view of the powered wheel illustrated in FIG. 2A, having one or more features consistent with implementations of the current subject matter;

FIG. 3 is an exploded view of a commercial embodiment of the powered wheel, having one or more features consistent with implementations of the current subject matter;

FIG. 4 is a schematic view of an electric circuit for powering an electric motor, having one or more elements consistent with the current subject matter;

FIG. 5 is an exploded perspective view of various elements of the skateboard deck, having one or more features consistent with implementations of the current subject matter;

FIG. 6 is a diagram of various elements of a powered skateboard, having one or more features consistent with implementations of the current subject matter;

FIG. 7 is a perspective view of various elements of the powered skateboard, having one or more features consistent with implementations of the current subject matter;

FIG. 8 is a schematic diagram of an exemplary embodiment of a system for controlling a motor of a powered skateboard, having one or more elements consistent with the current subject matter;

FIG. 9A is a schematic diagram of a powered skateboard, having one or more elements consistent with the current subject matter;

FIG. 9B is a schematic diagram of a front-end of a powered skateboard, having one or more elements consistent with the current subject matter;

FIG. 10 is an illustration of an object avoidance system for a powered skateboard, in accordance with one or more elements of the current subject matter;

FIG. 11 is an illustration of a system for providing augmented reality in conjunction with a powered vehicle, the system having one or more features consistent with the present description; and

FIG. 12 is an illustration of users using in a system with augmented virtual reality having one or more features consistent with the present description.

When practical, similar reference numbers denote similar structures, features, or elements.

### DETAILED DESCRIPTION

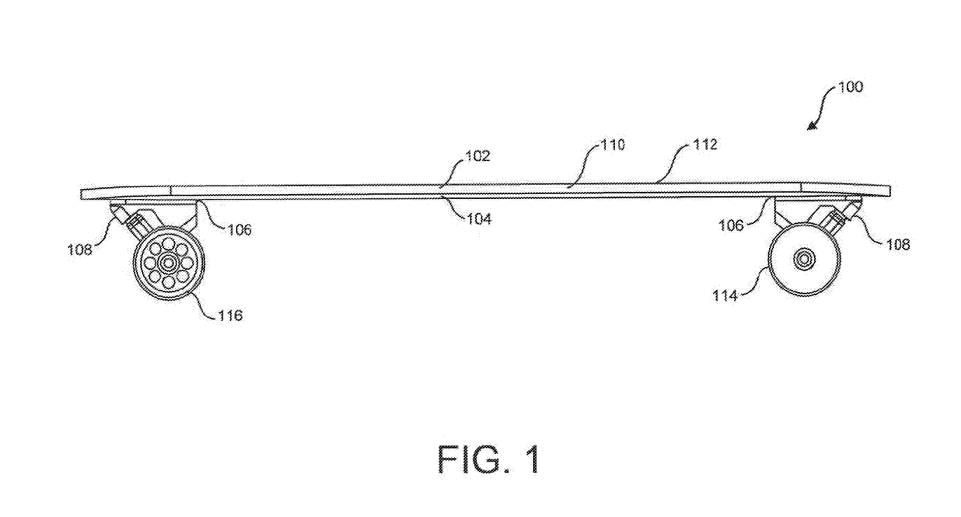

FIG. 1 is a side view of various elements of the skateboard 100, having one or more features consistent with implementations of the current subject matter. The skateboard 100 can comprise a skateboard deck 102. The skateboard deck 102 may comprise a bottom portion 104. The bottom portion 104 may have truck-mounting portions 106 configured to facilitate engagement with one or more skateboard trucks 108. The skateboard deck 102 may comprise a top portion 110. The top portion 110 may have an upper surface 112. The upper surface 112 may be configured to support a rider of the skateboard 100.

The one or more skateboard trucks 108 can be configured to support one or more wheels 114 and 116. In some variations, the skateboard trucks 108 may be configured to support unpowered wheels 114 and/or powered wheels 116. The powered wheels 116 can be disposed on both front and rear trucks 108 of the skateboard 100, or can be disposed on just one of the trucks 108. The powered wheels 116 can be disposed on one side or on both sides of the truck(s) 108. The powered wheels 116 can be disposed on the truck 108 that is located on the rear portion of the skateboard 100.

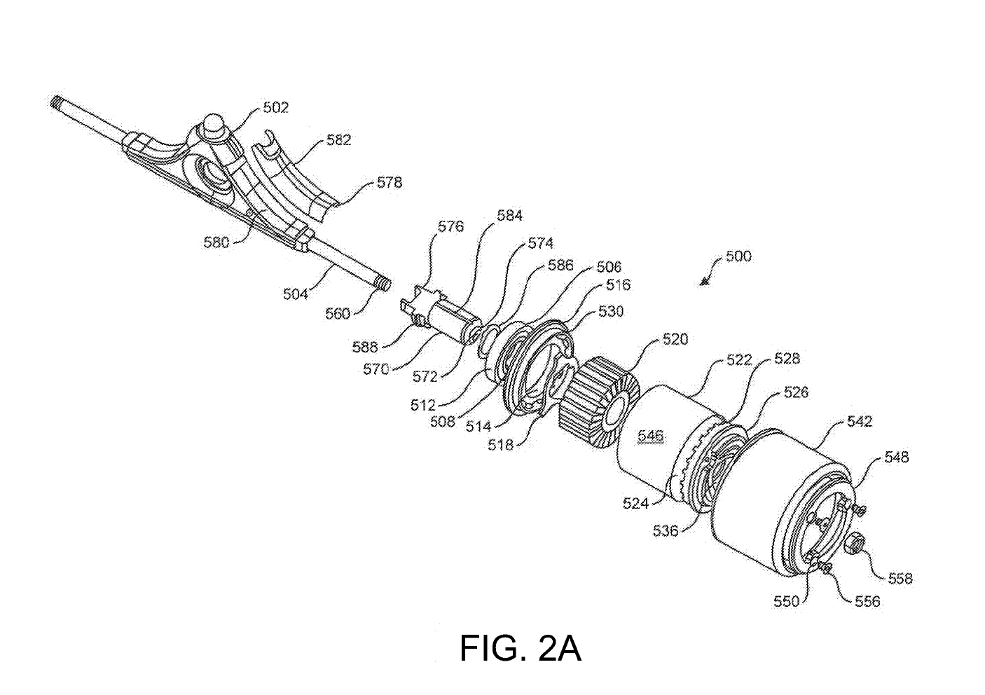

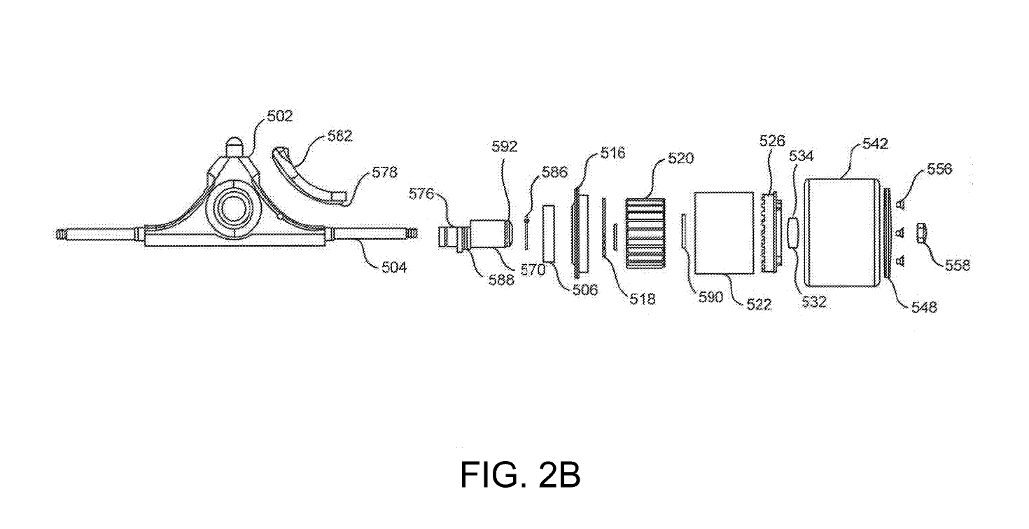

FIG. 2A is an exploded perspective view of a powered wheel 500, having one or more features consistent with implementations of the current subject matter. FIG. 2B is an exploded side view of the powered wheel 500. The powered wheel 500 can be configured to attach to a skateboard truck 502. The skateboard truck 502 can be a generic skateboard truck. The skateboard truck 502 can be a specialty skateboard truck configured to engage with the powered wheel 500. The skateboard truck 502 can include a skateboard axle 504.

The powered wheel can include a hub 570. The hub 570 can include a hollow through-portion 572. The hollow through-portion 572 can be configured to receive the axle 504 of the truck 502. The hub 570 can be have a length to facilitate a threaded portion 560 of the axle 504 to extend beyond the end 574 of the hub 570. The hub 570 can include a rotational hindering portion 576. The rotational hindering portion 576 can include a flattened portion. The rotational hindering portion 576 of the hub 570 can be configured to engage with a rotational hindering portion 578 engaged with the truck 502. The rotational hindering portion 576 of the hub 570 and the rotational hindering portion 578 of the truck 502 can have complementary shapes facilitating engagement of the two rotational hindering portions.

The truck 502 can include a conduit 580. The conduit can be configured to house electrical wiring. The electrical wiring can be disposed between a power source for the powered wheel 500 and the powered wheel 500. The conduit 580 can include a conduit cover 582. In some variations, the conduit cover 582 can include the rotational hindering portion 578 of the truck 502.

The hub 570 can include a channel 584. The channel 584 can be configured to house electrical wiring to at least the stator 520 of the powered wheel 500.

The powered wheel 500 can comprise a bearing 506. An inner race 508 of the bearing 506 can be configured to engage with at least a portion of the hub 570. An outer race 512 of the bearing 506 can be configured to engage with an inner surface 514 of an inner motor support 516. A clip 586 can be employed to secure the bearing 506 into the inner motor support 516. The clip 586 can be configured to engage with a lateral groove 588 of the hub 570. The lateral groove 588 can circumvent the hub 570. The clip 586, engaged with the lateral groove 588 can prevent components of the powered wheel 500 from moving too far inward toward the truck 502.

The powered wheel can include a position encoder 518. The position encoder 518 can include a PCB. The PCB can include one or more electrical components. The one or more electrical components can include at least one Hall effect sensor. The position encoder 518 can be disposed adjacent the stator 520.

A rotor can 522 can be provided to surround the stator 520. The rotor can 522 can include a plurality of magnets attached to the inner surface 524 of the rotor can 522. The rotor can 522 can be a magnetic flux ring. The magnetic flux ring can be configured to provide the same or similar functionality to having a plurality of magnets attached to the inner surface 524 of the rotor can 522.

The powered wheel 500 can include an outer motor support 526. The outer motor support 526 can include a flange 528 adapted to engage with an inner surface 524 of the rotor can 522. The inner motor support 516 can include a flange 530 adapted to engage with the inner surface 524 of the rotor can 522 opposite the outer motor support 526.

The powered wheel 500 can include an outer bearing 532. The outer bearing 532 can include an outer race 534. The outer race 534 can be configured to engage with an inner surface 536 of the outer motor support 526. The inner race (not shown) of the outer bearing 532 can be configured to engage with at least a portion of the hub 570. The inner bearing 506 and the outer bearing 532 can be configured to facilitate rotation of the inner motor support 516, stator 520, rotor can 522 and outer motor support 526 about the hub 570.

The powered wheel 500 can include an outer clip 590. The outer clip 590 can be configured to inhibit the components of the powered wheel 500 from moving outward. The outer clip 590 can be configured to retain the components of the powered wheel 500 on the hub 570. The outer clip 590 can be configured to engage with an outer lateral groove 592. The outer lateral groove 592 can circumvent the hub 570.

The powered wheel 500 can include a wheel 542.

The powered wheel 500 can include a retaining ring 548. The retaining ring 548 can be configured to hold the wheel 542 onto the motor. The retaining ring 548 can include one or more fastener holes 550. The one or more fastener holes 550 can be aligned with one or more fastener holes on the outer motor support 526. The retaining ring 548 can be configured to fit within a recess of the wheel 542. Fasteners 556 can be used to secure the retaining ring 548 to the outer motor support 526.

The powered wheel 500 can include a retaining bolt 558. The retaining bolt 558 can be configured to screw onto a threaded portion 560 of the axle 504. The retaining bolt 558 can be configured to retain the outer bearing 532 on the axle 504. In some variations, the outer clip 590 can be integrated with the retaining bolt 558, the retaining ring 548, a combination thereof, or the like.

In some variations, the hub 570 may include an axle binding device. The axle binding device configured to bind the hub 570 onto the axle 504. The retaining bolt 558 can be configured to retain the powered wheel 500 onto the hub 570.

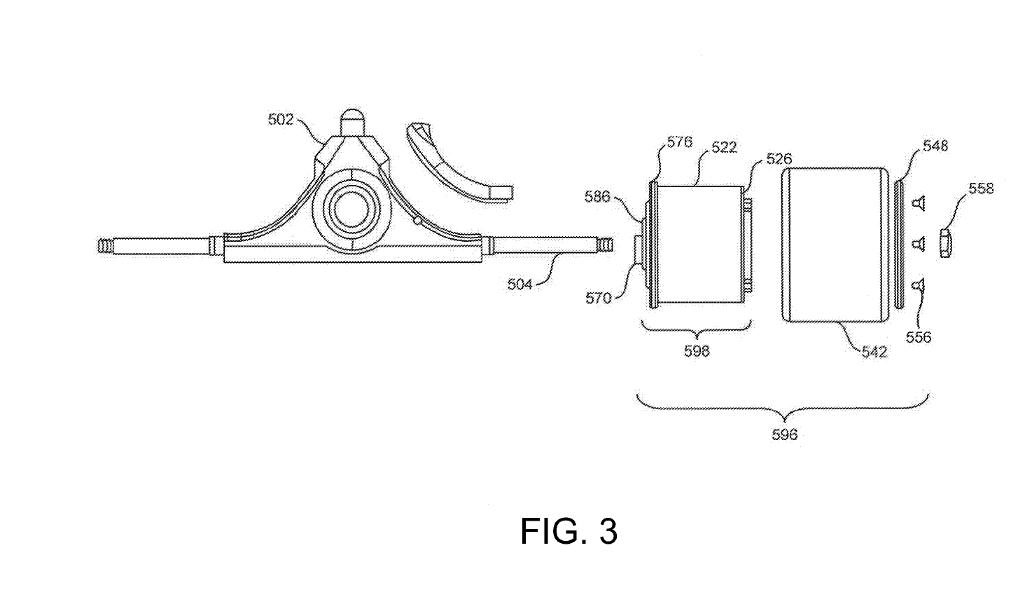

FIG. 3 is an exploded view of a commercial embodiment of a powered wheel 500, having one or more features consistent with the current subject matter. The powered wheel 500 may be supplied as a powered wheel unit 596. The powered wheel 500 may be supplied with the motor unit 598, the wheel 542, the retaining ring 548, fasteners 556 and retaining bolt 558 fully assembled. In some variations, the wheel 542 may be supplied separately, or replacement wheels 542 may be supplied. The retaining ring 548 and fasteners 556 can be configured to facilitate easy replacement of the wheel 542.

While the presently described powered wheels 100 and 500 are illustrated and discussed in relation to being provided for a skateboard, the present disclosure contemplates that the powered wheels can be provided for any item having an axle. For example, the presently described powered wheels can be provided for luggage, bicycles, shopping carts, wheel chairs, and the like. The relative size of the components of the presently described powered wheels can be modified to fit the intended purpose of the powered wheel and the medium on which the powered wheel is intended to be disposed.

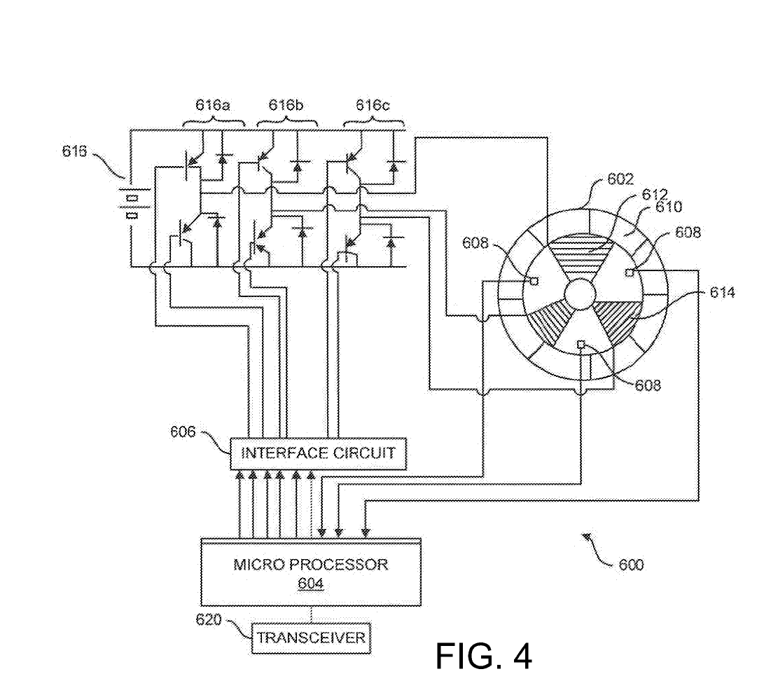

FIG. 4 is a schematic view of an electric circuit 600 for powering an electric motor 602, having one or more elements consistent with the current subject matter. The electric motor 602 illustrated in FIG. 4 is a representation only. The configuration of the stator and the rotor are not intended to be limiting. The electric motor 602 may be a three-phase motor, as shown.

The electric motor 602 may be controlled by one or more microprocessors 604. The microprocessor(s) may be configured to control the electric motor 602 through an interference circuit 606. The electric motor 602 may include one or more hall sensors 608. The hall sensor(s) 608 can be configured to vary its output voltage based on the magnetic field experienced by the hall sensor(s) 608. As the rotor 610 of the electric motor rotates about the stator 612, the magnetic field at the hall sensor(s) 608 will change. The change in the magnetic field at the hall sensor(s) 608 can be measured such that the output voltage of the hall sensor(s) 608 can be mapped to the position of the stator teeth 614. Consequently, the positions of the stator teeth associated with different phases of an n-phase electric motor 602 can be known based on the output voltage of the hall sensor(s) 608. The microprocessor 604 can be configured to receive an indication of the output voltage of the hall sensor(s) 608 and control the current provided to the different phases of the n-phase motor 602.

An electrically powered vehicle, such as the skateboard 100, can further include a memory configured to store a software. The electrically powered vehicle can further include a receiver configured to receive, over a wireless data connection, updated software to store in the memory, and wherein the controller is further configured to use the updated software to control the electric motor 602. The software can facilitate variable control of the electric motor 602 or a component of the electric motor 602.

Each phase of the n-phase motor 602 can be associated with a rectifier 616a, 616b and 616c. While semiconductor rectifiers are illustrated, the current subject matter contemplates any type of rectifier, including vacuum tube diodes, mercury-arc valves, copper and selenium oxide rectifiers, semiconductor diodes, silicon-controlled rectifiers and other silicon-based semiconductor switches.

The electric motor 602 can be powered by a power supply 618. The power supply 618 can also be configured to provide power to the microprocessor(s) 604. The microprocessor(s) 604 can be in direct or indirect electronic communication with a transceiver 620. The transceiver 620 can be configured to transmit and/or receive signals from one or more input devices.

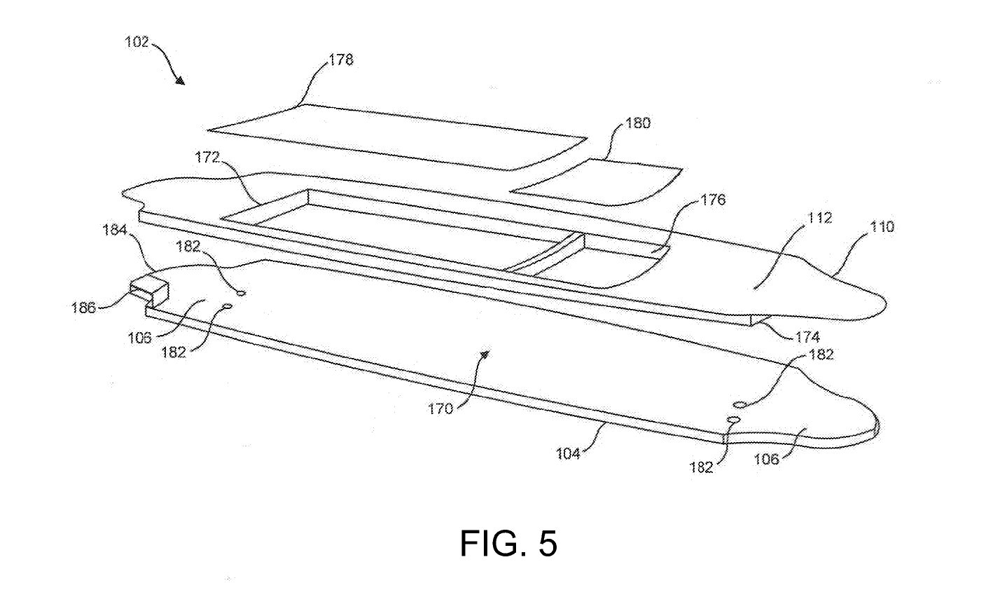

FIG. 5 is an exploded view of various elements of the skateboard deck 102, having one or more features consistent with implementations of the current subject matter. The skateboard deck 102 may comprise a bottom portion 104. The bottom portion 104 may have truck mounting portions 106 configured to facilitate engagement with one or more skateboard trucks 108 (as shown in FIG. 1).

The skateboard truck(s) 108 can be made from aluminum. The skateboard truck(s) 108 can comprise an axle 118 that extends horizontally from one wheel to the other wheel. The skateboard truck(s) 108 can comprise multiple axles that extend outward from the skateboard truck(s) 108 on either side of the skateboard truck(s) 108. Each skateboard truck can be configured to have each wheel positioned between about 120 mm and about 180 mm apart. The skateboard truck(s) 108 can be mechanically attached to the skateboard by bolts.

The skateboard deck 102 may comprise a top portion 110. The top portion 110 may have an upper surface 112. The upper surface 112 may be configured to support a rider of the powered skateboard 100. The skateboard deck 102 may have a cavity 170. The cavity 170 may be disposed between the bottom portion 104 and the top portion 110 of the skateboard deck 102. The cavity 170 may be adapted to store one or more components of the powered skateboard 100.

The top portion 110 of the skateboard deck 102 may include an aperture 172. The aperture 172 may be configured to facilitate access to the cavity 170 between the top portion 110 and the bottom portion 104 of the skateboard deck 102.

The bottom portion 104 of the skateboard deck 102 may include support structures. The top portion 110 of the skateboard 102 may include support structures 174. The support structures may be configured to provide support for the top portion 110 of the skateboard deck 102 to facilitate the top portion 110 to support a rider of the powered skateboard 100. The support structure can be configured as a honeycomb structure. The support structure can include one or more lateral and/or longitudinal support structures.

In some variations of the current subject matter, the top portion 110 of the skateboard deck 102 may comprise multiple apertures 172, 176. One aperture 172 may be configured to facilitate access to components of the powered skateboard 100 that may be regularly removed. Such regularly removed components may include a fuel source for the powered skateboard 100 and/or a container for the fuel source of the powered skateboard 100. Another aperture 176 may be configured to facilitate access to components of the powered skateboard 100 that are not regularly removed. Such components not regularly removed may be control systems for controlling the powered skateboard.

The components may include a transceiver 620 (as shown in FIG. 4) configured to communicate with one or more mobile devices. The transceiver 620 may be one or more of a Wi-Fi transceiver, a Bluetooth transceiver, a Near-Field-Communication transceiver, a sub-gigahertz transceiver, and/or any other wireless communication transceiver. The transceiver 620 may be in electronic communication with the control system for the powered skateboard. The control system may be configured to modify one or more parameters of the powered skateboard.

A lid 178 can be provided for the aperture 172. The lid 178 can be configured to cover the aperture 172 and provide support to a rider of the powered skateboard 100. The lid 178 can be configured to be screwed in place to cover the aperture 172 and provide support to the rider. The lid 178 can be configured to attach to the top portion 110 of the skateboard deck 102 via a hinge, a latch, a connector, or any other connection mechanism. The top portion 110 of the skateboard deck 102 can comprise slots to engage with the lid 178, such that the lid 178 can slide into the slots and cover the aperture 172 and support the rider. The lid 178 may be removably engaged with the top portion 110 of the skateboard deck 102.

Having the lid 172 removably engaged with the top portion 110 of the skateboard deck 102 can facilitate a user of the powered skateboard to access one or more components of the powered skateboard stored in the cavity 170. For example, the powered skateboard may be electrically powered. The cavity 170 can be configured to store one or more battery packs to provide electrical power to one or more electric motors of the powered skateboard. Having the lid 178 removably engaged with the top portion 110 of the skateboard deck 102 can facilitate a user to exchange a spent battery pack with a charged battery pack. A user may, therefore, be able to continue using the powered skateboard.

In variations where the skateboard deck 102 includes multiple apertures 172, 176, the aperture 176 for providing access to non-regularly removed components of the powered skateboard 100 may be covered by a lid 180. The lid 180 for covering aperture 176 can be secured such that the lid 180 is not easily removed, and may withstand a tumbling of the skateboard or any other shock. The lid 180 for covering aperture 176 can be secured to the top portion 110 of the skateboard deck 102 using screws, adhesive, and/or other securing methods.

The skateboard deck 102 can include one or more conduits 182. The one or more conduits 182 may be configured to facilitate connections between the power source and the motive source for the powered skateboard 100. The one or more conduits 182 can be configured to facilitate connections between an electrical power source disposed in the cavity 170 of the skateboard deck 102 and one or more electric motors disposed outside of the cavity 170 of the skateboard deck 102.

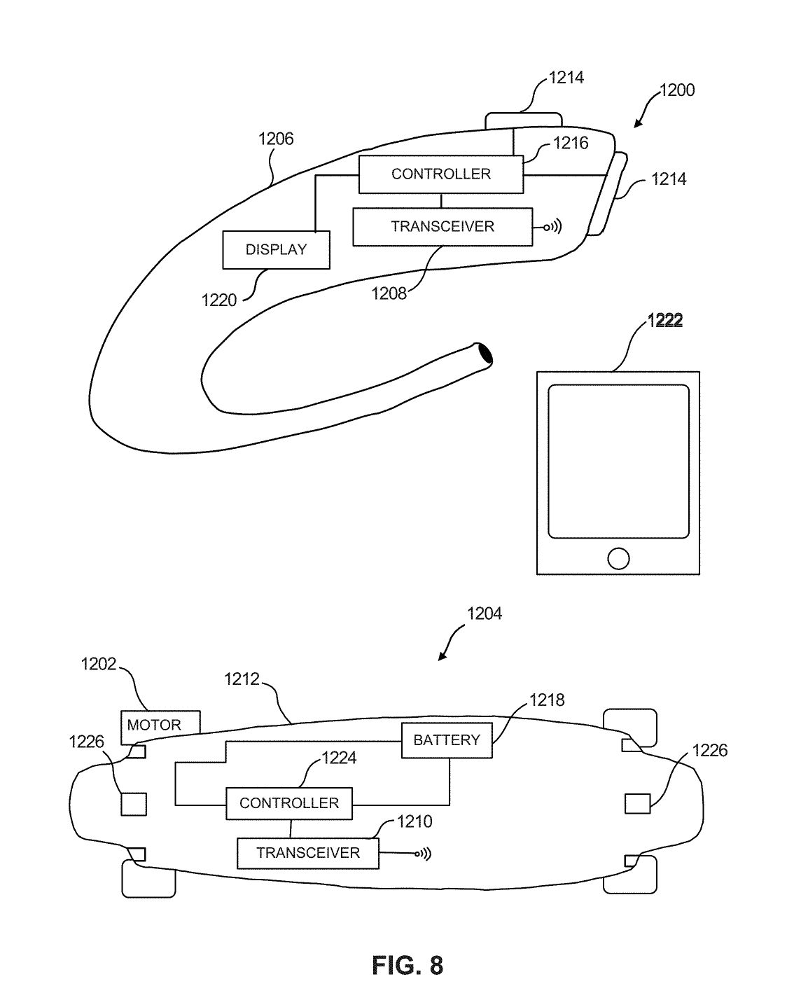

The components stored in the cavity 170 between the top portion 110 and the bottom portion 104 of the skateboard deck 102 may include a receiver, transmitter, and/or transceiver, herein referred to as a transceiver. The transceiver may be adapted to receive instructions from a user to control the powered skateboard 100. Instructions may be received from a transmitter. The transmitter may include a hand-held transmitter (such as shown in FIG. 8).

The skateboard deck 102 can include a port aperture 184. The port aperture 184 can be configured to secure an electronic port 186 into the skateboard deck 102. The electronic port 186 can be one or more of a USB port, a FireWire port, and/or other electronic port. The electronic port 186 can be configured to facilitate communications between an external device and one or more components of the powered skateboard 100. The electronic port 186 can be configured to facilitate transfer of electrical energy to one or more components of the powered skateboard 102. The electronic port 186 may be configured to facilitate transfer of electrical energy from one or more components of the powered skateboard to an external device.

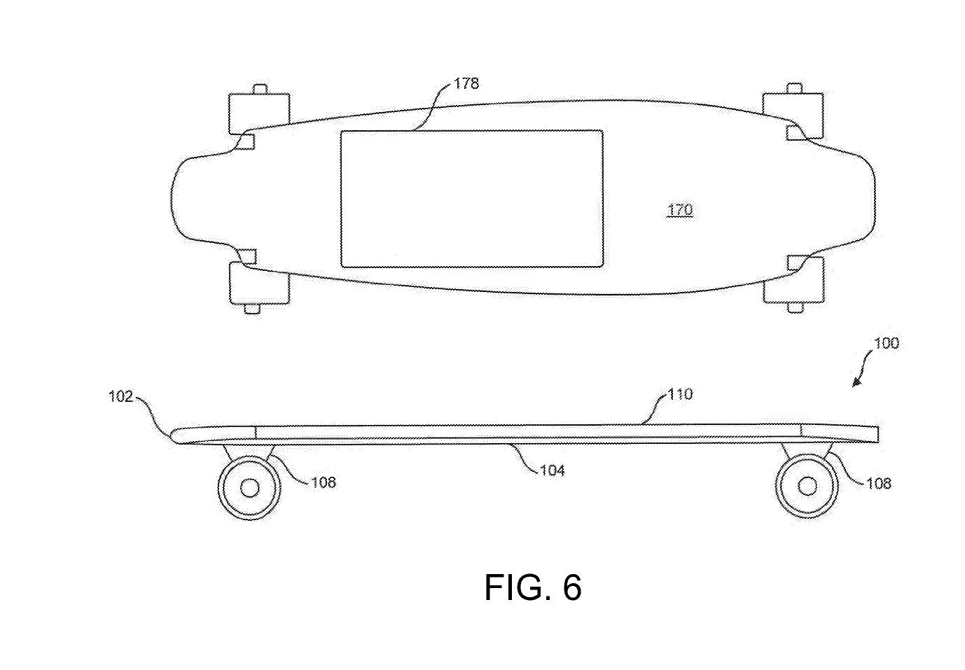

FIG. 6 is a diagram of various elements of a powered skateboard 100, having one or more features consistent with implementations of the current subject matter. The top portion 110 of the skateboard deck 102 may be secured to the bottom portion 104 of the skateboard deck 102. The top portion 110 of the skateboard deck 102 may be secured to the bottom portion 104 of the skateboard deck 102 by one or more of screws, adhesive, welding, mechanically fastening, and/or other securing mechanism. The top portion 110 of the skateboard deck 102 may be contiguous with the bottom portion 104 of the skateboard deck 102. The skateboard deck 102 may have a monocoque structure.

The skateboard deck 102 may comprise injection molded plastic. The skateboard deck 102 may comprise thermoplastic. The skateboard deck 102 may comprise carbon fiber. The skateboard deck 102 may comprise forged carbon fiber. The skateboard deck 102 may comprise pre-preg carbon fiber.

The components of the skateboard deck 102 may have a modular structure. The modular structure may have a polygonal structure. The polygonal structure may be hexagonal or rectangular. The polygonal structure may provide a lightweight structure while maintain strength and stability of the components of the skateboard deck 102.

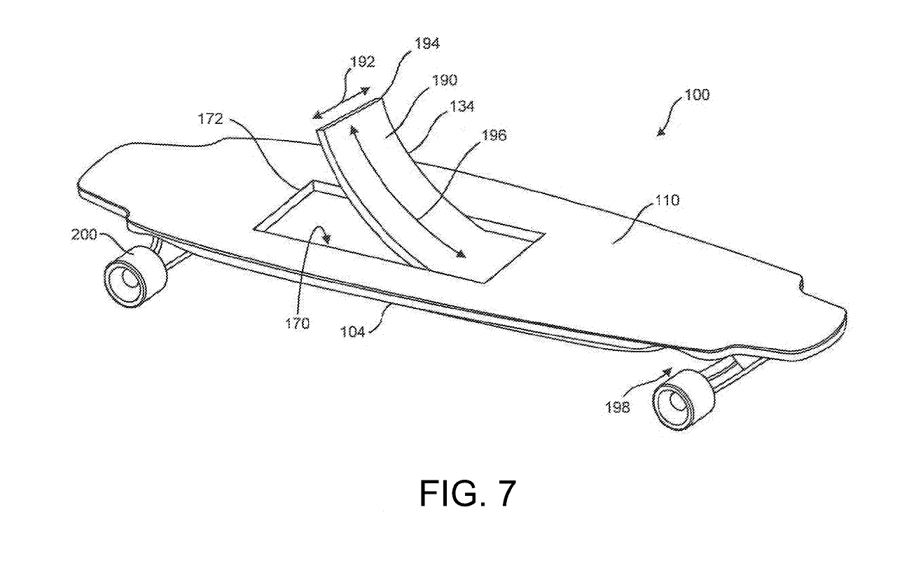

FIG. 7 is a perspective view of various elements of the powered skateboard 100, having one or more features consistent with implementations of the current subject matter. The powered skateboard 100 may be electrically powered. The one or more components stored in the cavity 170 between the top portion 110 and the bottom portion 104 can include a power source for providing electrical power to one or more electric motors of the electrically-powered skateboard. The power source may include a battery pack 190.

In some variations, the one or more components of the powered skateboard 100 can be stored under the deck 102 of the powered skateboard.

A battery pack 190 contemplated by the current subject matter may be interchangeable. The battery pack 190 contemplated by the current subject matter may have a width 192 suitable to fit within the cavity 170 of the skateboard deck 102 for the presently disclosed powered skateboard 100. The battery pack 190 contemplated by the current subject matter may have a thickness 194 suitable to fit within the cavity 170 of the skateboard deck 102 for the presently disclosed powered skateboard 100. The battery pack 190 contemplated by the current subject matter may have a length 196 suitable to fit between the front 198 and back 200 truck mounting portions of the skateboard deck 102. The battery pack 190 contemplated may be configured to be removable from the skateboard deck 102. For example, when a battery pack has been depleted it may be exchanged for a charged battery pack. The battery pack 190 may be flexible to facilitate removing and/or exchanging the battery pack 190 into the cavity 170 of the skateboard deck 102.

The battery pack 190 may include a casing. The casing may have a shape and/or dimensions adapted to secure the battery pack 190 within one or more cavities 170 of the skateboard deck 102. The casing may include a flange encircling the battery pack 190. The flange may be configured to engage with complimentary receiving portions in the cavity 170 of the skateboard deck 102. The flange and complimentary receiving portions may be configured to secure the battery pack inside the cavity 170 of the skateboard deck 102. The lid 178 may facilitate securing the battery pack 190 into the cavity 170 of the skateboard deck 102.

The battery pack 190 can be a battery providing between 12 and 50 volts. The battery pack 190 can be comprised of any type of battery. The battery pack 190 can comprise a Lithium Ion type battery. The battery pack 190 can include blade or fin connectors. The battery pack 190 can include connectors to electrically connect the battery pack 190 to one or more other components of the powered skateboard 100.

FIG. 8 is a schematic diagram of an exemplary embodiment of a system 900 for controlling a motor 902 of a powered skateboard 904. The control system 900 may include a handheld device 906. The handheld device 1206 may comprise a transceiver 1208. While transceivers are illustrated in FIG. 8, transmitters and/or receivers are contemplated by the current subject matter. The illustrated transceiver 1208 is intended to represent a transceiver, a separate transmitter, a separate receiver, a single transmitter, a single receiver, multiple transmitters, multiple receivers, or any combination thereof. The transceiver 1208 can be a wireless transceiver. The transceiver 1208 can be configured to transmit and/or receive radio frequency signals. The transceiver 1208 can be configured to transmit and/or receiver other signal types, such as audio signals, light signals, and/or other signals.

In some variations, a controller 1210 can be co-located with the motor 1202. The controller 1210 can be in electrical contact with the motor 1202. The controller 1210 can be embedded with the motor 1202. The controller 1210 can be disposed within the deck 1212 of the powered skateboard 1204. The transceiver 1208 in the handheld device 1206 can be configured to transmit information to, and/or receive information from, the controller 1210 in response to an input received at the handheld device 1206 through one or more of the input devices 1214 of the handheld device 1206.

Although FIG. 8 shows two input devices 1214 this is not intended to be limiting. The illustration of the two input devices 1214 is illustrative only and the current subject matter contemplates any number of input devices 1214. The input device(s) 1214 itself can be configured to receive multiple types of input from a user. The input device(s) 1214 can include one or more of a button, a slider, a wheel, a sensor, and/or other input devices. The input device(s) 1214 can be configured to detect an increase in pressure exerted by the user on the input device(s) 1214. In some variations, the input device(s) 1214 can be configured to detect a squeezing of the handheld device 1206 by the user. In some variations, the input device(s) 1214 can be variable input devices configured to detect a degree of pressure, or a degree of input, provided by the user.

The handheld device 1206 can include a controller 1216. The controller 1216 can be configured to cause the transceiver 1208 to transmit instructions to, and/or receive instructions from, the motor 1202. The instructions can control the motor 1202 in accordance with the inputs received through the input devices 1206.

The powered skateboard 1204, may include a transceiver 1210. The transceiver 1210 can be configured to transmit and/or receive information associated with the operation of the powered skateboard 1204. The transceiver 1210 can be configured to transmit and/or receive radio-wavelength signals. The transceiver 1210 can be configured to transmit and/or receive one or more of Wi-Fi signals, Bluetooth signals, Near-Field-Communication signals, and/or other signal formats and/or wavelengths.

The transceiver 1210 can be configured to transmit information associated with the operation of the powered skateboard 1204. Where the motor 1202 is an electric motor powered by a battery 1218, the information transmitted by the transceiver 1210 can include a level of charge of the battery 1218 and/or other information associated with the battery 1218. The transceiver 1208 of the handheld device 1206 can be configured to receive information associated with the operation of the powered skateboard 1204. For example, the information received can be associated with the charge level of the battery 1218, a performance level of the motor 1202, the strength of the signal between the transceiver 1210 of the powered skateboard 1204 and the transceiver 1208 of the handheld device 1206.

The handheld device 1206 can include a display unit 1220. The display unit 1220 can be configured to display information associated with the operation of the motor 1202. The display unit can be configured to display a charge level of the battery 1218 used to provide power to the electric motor. The display unit may be an LED display, a touchscreen display, a series of lights indication a charge level, and/or any device capable of conveying to a user the transmitted information.

The handheld device 1206 and/or the powered skateboard 1204 can include a transceiver 1208, 1210, respectively, configured to communicate with external devices 1222. In some variations, the handheld device 1206 and the powered skateboard 1204 can communicate with the external devices, such as external device 1222, through one another. For example, the transceiver 1210 of the powered skateboard 1204 can communicate with the transceiver 1208 of the handheld device 1206 providing information associated with the powered skateboard 1204. The handheld device 1206 can, in turn, communicate that information with an external device, such as external device 1222. In some variations, the transceiver 1208 of the handheld device 1206 can communicate information to the transceiver 1210 of the powered skateboard 1204. The powered skateboard 1204 can, in turn, cause the information to be transmitted to the external device 1222.

Information provided by the handheld device 1206 and/or the powered skateboard 1204, to the external device 122 may include, but not be limited to, battery charge information, speed information, mode of operation information, acceleration information, status information, error information, damage information, a mode of operation of the motive device, a length of time of operation of the motive device and other information associated with the motive device. The external device 1222 can include one or more of a smartphone, a tablet, a computer, a laptop, a smartwatch, a vehicle, and/or other external device capable of receiving the information. The external device 1222 can facilitate presentation of information associated with the powered skateboard 1204 and/or handheld device 1206 to a user. For example, the external device 1222 can facilitate the presentation of the maximum speed, maximum acceleration, average speed, average acceleration, length of time in operation, distance travelled, and/or other information associated with the operation of the powered skateboard 1204.

The external device 1222 may be configured to receive input. The inputs may correspond to one or more modes and/or elements of the powered skateboard 1204 and/or the handheld device 1206. Inputs and/or entries entered through an external device 1222 may select a user for the powered skateboard 1204. The powered skateboard 1204, handheld device 1206, external device 1222, and/or other devices, may be configured to store information about different users, such as user preferences. In response to receiving an indication that a particular user is going to use the powered skateboard 1204, the powered skateboard 1204 may be configured with the preferred settings of that user. Inputs and/or entries entered through an external device 1222 can render the powered skateboard 1204, inoperable. The communications between the external device 1222, the powered skateboard 1204, and/or the handheld controller 1206 can be via a wireless communication medium. Such wireless communication medium may include radio signals. Such radio signals may include Bluetooth signals and/or other short-range and/or long range radio signals.

The motor 1202 and/or the controller 1224 of the powered skateboard 1204 can be configured to have one or more modes. The one or more modes can be associated with performance characteristics of the powered skateboard 1204. For example, the powered skateboard 1204 can have beginner, advanced, eco, custom and/or other modes. Different modes may include settings, such as maximum speed, maximum acceleration, maximum distance from home, and/or other information. A user may select and/or enter a mode on the handheld device 1206. The user may select and/or enter a mode on the external device 1222. The mode selection and/or entry can be transmitted by the transceiver 1208 to the transceiver 1210 of the powered skateboard 1204. The transceiver 1210 of the powered skateboard 1204 can be connected directly with the motor 1202 or can be connected to a controller 1210. The selected and/or entered mode received from the handheld device 1206 can cause the controller 1210 and/or motor 1202 to have performance characteristics associated with the selected and/or entered mode.

One or more input devices 1214 of the handheld device 1206 can be configured to cause changes in the speed of the motor 1202. One or more input devices 1214 can be configured to cause changes in the rate of acceleration of the motor 1202. Speed and/or acceleration information may be transmitted by transceiver 1208 of the handheld device 1216 to transceiver 1210 of the powered skateboard 1204. The transceiver 1210 can be configured to provide the speed and/or acceleration information to the controller 1224 and/or the motor 1202, depending on the configuration of the handheld device 1206 and the powered skateboard 1204. One or more input devices 1214 can include a kill switch. The kill switch can be configured to deactivate the motor 1202 in response to the kill switch being activated. In some variations, the kill switch may be activated by the kill switch being pressed. In other variation, the kill switch may be activated by a user releasing the kill switch.

In some variations, the powered skateboard 1204 can include one or more pressure sensitive devices 1226. The pressure sensitive device(s) 1226 can be configured to detect a pressure exerted on the deck 1212 of the powered skateboard 1204. The pressure sensitive device(s) 1226 can be calibrated to detect the weight of a rider on the deck 1212. The pressure sensitive device(s) 1226 can be connected to the controller 1224. The controller 1224 can be configured to monitor the pressure exerted on the pressure sensitive device(s) 1226 over time. Users of the powered skateboard 1204 can develop a pattern when using the powered skateboard 1204, such that the controller 1224 can be configured to learn how a particular user exerts pressure on the deck 1212 during operation of the powered skateboard 1204. The controller 1224 can be configured to detect a situation where the user has broken their usual pattern. A user may break their usual pattern by falling off of the powered skateboard 1204. In such cases, the controller 1224 can be configured to reduce the speed of the powered skateboard 1204 and/or stop it.

The pressure sensitive device(s) 1226 can be disposed in the trucks of the powered skateboard 1204. The pressure sensitive device(s) 1226 can be disposed between the deck 1212 and the trucks of the powered skateboard 1204. The pressure sensitive device(s) 1226 can be calibrated for the user's weight during an initial set-up of the powered skateboard 1204 by the user.

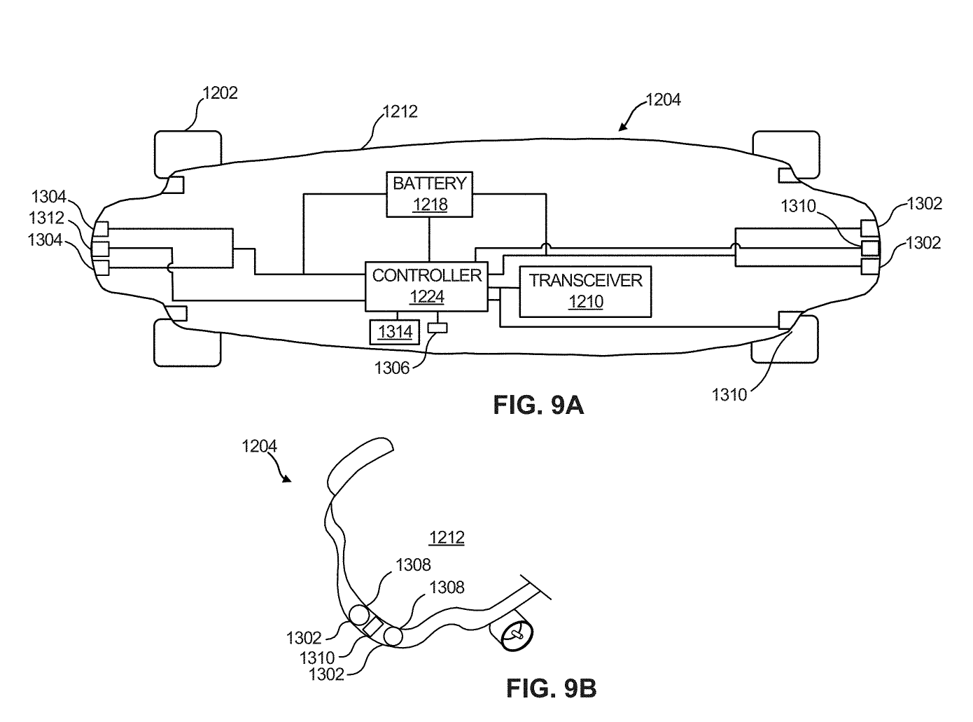

FIG. 9A is a schematic diagram of a powered skateboard 1204. FIG. 9B is a schematic diagram of a front-end of a powered skateboard 1204. The powered skateboard 1204 can be similar to the powered skateboard 1204 illustrated in FIG. 8. The powered skateboard 1204 can include a deck 1212. The deck 1212 can include one or more forward facing lights 1302. The deck 1212 can include one or more rear facing lights 1304. The lights 1302 and 1304 can be powered by the battery 1218. The forward facing lights 1302 and the rear facing lights 1304 can be a light emitting diode (LED).

The powered skateboard 1204 can include a controller 1224. The controller 1224 can be configured to facilitate control of the powered skateboard 1204. The controller 1224 can be configured to control an electric motor 1202. The controller 1224 can be configured to control the lights 1302 and 1304.

The front facing lights 1302 can be configured to illuminate the direction of travel in front of the powered skateboard 1204. The front facing lights 1302 can be integrated into the skateboard deck 1212. The skateboard deck 1212 can be configured to include channels for receiving the front facing lights 1302 and the rear facing lights 1304. The skateboard deck 1212 can include ports 1308 configured to accept the lights 1302 and 1304. The ports 1308 can be configured to include water resistant material to prohibit ingress of water through the ports 1308.

The powered skateboard 1204 can include a photo sensor 1306. The photo sensor 1306 can be configured to detect when the powered skateboard 1204 is in the dark. The photo sensor 1306 can be in electronic communication with a controller 1224. In response to the photo sensor 1306 detecting that the powered skateboard 1204 is in the dark, the controller 1224 can be configured to cause the forward facing lights 1302 to illuminate. In some variations, the controller 1224 can be configured to cause the forward facing lights 1302 to illuminate at predefined times of day.

The controller 1224 can be configured to cause the rearward facing lights 1304 in response to the photo sensor 1306 detecting that the powered skateboard 1204 is in the dark. The controller 1224 can be configured to cause the rearward facing lights 1304 in response to an indication that the powered skateboard 1204 is decelerating. Deceleration of the powered skateboard 1204 that can cause the controller 1224 to cause the rearward facing lights 1304 to illuminate can include purposeful deceleration. Purposeful deceleration is deceleration cause by retardation of forward motion by the one or more motors 1202 of the powered skateboard 1204. In variations, where the rearward facing lights 1304 are illuminated due to the powered skateboard 1204 being in the dark, the controller can cause the rearward facing lights 1304 to illuminate with more intensity.

While FIGS. 9A and 9B shows lights 1302 and 1304 embedded in the skateboard 1212, the current subject matter contemplates the lights 1302 and 1304 being disposed in one or more other locations of the powered skateboard 1204.

The powered skateboard 1204 can include one or more cameras 1310, 1312. The powered skateboard 1204 can include one or more front-facing cameras 1310 and/or one or more rear-facing cameras 1312. The one or more cameras can be in electronic communication with the controller 1224. The controller 1224 can be configured to manage the cameras 1310 and 1312. The controller 1224 can include electronic data storage. The controller 1224 can be in electronic communication with electronic data storage. The cameras 1310, 1312 can be configured to obtain still images and/or video images. The video images can include multiple still images taken in quick succession. The images taken by the cameras 1310, 1312 can be stored on electronic data storage managed and maintained by the controller 1224.

In some variations, the controller 1224 can be in electronic communication with one or more motion sensors 1314. The one or more motion sensors 1314 can include a gyroscope, accelerometer, mercury switch, compass, GPS receiver, and/or other sensors. In response to an acceleration of the powered skateboard 1204 in any direction, detected by the motion sensor(s) 1314, the controller can cause the cameras 1310 and 1312 to obtain still images and/or video images. The still images and/or video images can be stored on electronic data storage.

The one or more sensors 1314 can be disposed on the powered skateboard 1204 through the skateboard deck 1212. Multiple sensors of a particular sensor type can be incorporated into the powered skateboard 1204. Multiple sensors of different sensor type can be incorporated into the powered skateboard 1204. In some variations, sensors integrated into the handheld controller 1206 and/or the external device(s) 1222 can augment information provided by the sensor(s) 1314. For example, the external device(s) 1222 can include a GPS receiver. Data received by the GPS receiver of the external device(s) 1222 can be received by the controller 1224 through a transceiver 1210 connected to the controller 1224.

Motion sensors 1314 can be configured to determine an orientation of the powered skateboard 1204. In particular, motion sensors 1314 can provide information to the controller 1224 that the powered skateboard 1204 is performing a manual, or wheelie. In some instances, a user may deliberately perform a manual. In other instances, a user may accidentally perform a manual because the their center of mass has been displaced to a position that makes them instable on the powered skateboard 1204, for example, aft of the rear axle. In circumstances where the user intends to perform a manual the user can provide input to configure the powered skateboard 1204 for performing such tricks. In circumstances where the user performs an accidental manual by having their center of mass at an unstable location, the powered skateboard 1204 can be configured to facilitate bringing the center of mass of the user, and/or a center of mass of the powered skateboard 1204, forward of the rear axle.

The motion sensor(s) 1314 can provide an indication to the controller that the powered skateboard 1204 is in a manual position. The motion sensor(s) 1314 can be configured to provide such indication in response to a detection that the powered skateboard has reached or exceeded a threshold angle compared the surface on which the powered skateboard it travelling. The motion sensor(s) 1314 can be configured to continuously provide an indication of the angle, and the controller 1224 can be configured to intervene when the powered skateboard is at or exceeds a threshold angle. The controller 1224 can recognize an accidental manual, which can mean that the center of mass of the rider is likely behind the rear axle or is moving toward a position behind the rear axle. In some variations, this can be verified by the powered wheels 1202 providing an indication to the controller 1224 that they are experiencing an accelerative force due to the rider's center of mass moving further rearward of the rear axle. The controller 1224 can be configured to reduce the speed of the electric wheels 1202 and in some cases reverse the electric wheels 1202 to facilitate bring the user's center of mass back in front of the rear axle of the powered skateboard 1204.

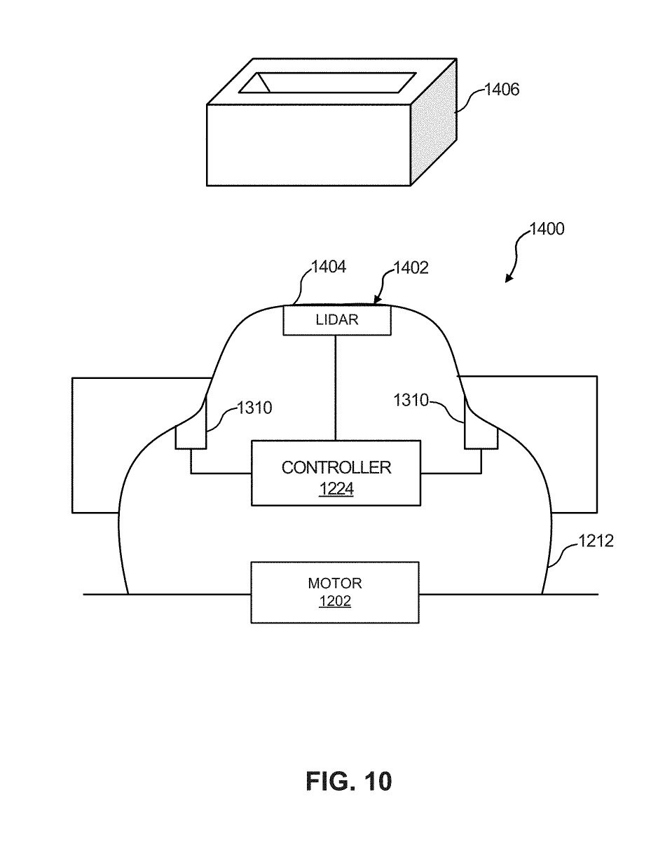

FIG. 10 is an illustration of an object avoidance system 1400 for a powered skateboard, in accordance with one or more elements of the current subject matter. The object avoidance system 1400 can include LIDAR, or stereo imaging. The object avoidance system 1400 can include an electromagnetic wave source 1402 configured to emit electromagnetic waves. The object avoidance system 1400 can include multiple electromagnetic wave sources 1402. The electromagnetic wave sources 1402 can be disposed in the deck 1212 of a powered skateboard. The electromagnetic wave sources 1402 can be disposed in the deck 1212 at various locations. The electromagnetic wave sources 1402 can include, but are not limited to ultraviolet, visible, near infrared, infrared, and other electromagnetic wave emitters. The electromagnetic waves emitted by the electromagnetic wave sources 1402 can be configured to illuminate objects 1406 within the field of the electromagnetic waves. The electromagnetic wave source 1402 can be selected to emit a wavelength corresponding to the types of objects 1406 likely to be encountered by the powered skateboard. The electromagnetic wave source 1402 can be a laser. The laser can be configured to emit light at a wavelength between 100-2000 nm. The laser can be configured to emit light at a wavelength that is not focused by the eye. For example, the laser can be configured to emit light at a wavelength of approximately 1550 nm. The electromagnetic wave source 1402 can be configured to emit a pulse of electromagnetic waves.

The object avoidance system 1400 can include a light backscattering detector 1404. The backscattering detector 1404 can be configured to detect light backscattered by one or more of Rayleigh scattering, Mie scattering, Raman scattering, fluorescence, or another type of scattering. The object avoidance system 1400 can include a scanner. The scanner can be configured to scan the backscattered light. Optics, such as mirrors and/or lenses can be used to facilitate the scanning of the backscattered light.

The backscattering detector 1404 can include a photodetector. The photodetector can include a solid state photodetector, a photomultiplier and/or another type of photodetector. The backscattering detector 1404 can include receiver electronics. The sensitivity of the receiver can be selected to facilitate object detection of the kinds of objects likely encountered by a powered skateboard.

The object avoidance system 1400 can be connected to the controller 1224. The controller 1224 can be configured to receive data signals from the detector 1404 representative of scans obtained by the detector 1404. The controller 1224 can be configured to analyze the scans to determine whether there is an obstacle in the path of the powered skateboard.

In some implementations, the object avoidance system 1400 can include one or more cameras 1310. The camera(s) 1310 can be configured to scan and/or capture images of the path ahead of the powered skateboard. The camera(s) 1310 can be electronically connected to a controller 1224. The controller 1224 can be configured to determine whether there is an obstacle in the path of the powered skateboard.

In response to determining that there is an obstacle in the path of the powered skateboard, the controller 1224 can be configured to slow the powered skateboard by reducing the angular momentum of the powered wheel 1202. In some variations, the controller 1224 can be configured to slow the powered skateboard to a stop. The controller 1224 can be configured to reduce the speed of the powered skateboard to facilitate maneuver of the powered skateboard around the obstacle by the rider. The controller 1224 can be configured to stop or slow the powered skateboard based on the type or size of the obstacle detected.

In response to determining that there is an obstacle in the path of the powered skateboard, the controller 1224 can be configured to provide haptic feedback. Such haptic feedback can include a vibration. The controller 1224 can be configured to cause a connected mobile device to provide a notification. The controller 1224 can be configured to cause, by the one or more components of the powered skateboard 100, or a connected smartphone, recordation of events prior to detection of an obstacle, during detection of the obstacle, after detection of the obstacle, and the like. The object avoidance system 1400 can be activated when the powered skateboard is being operated in the dark. The object avoidance system 1400 can be configured to detect obstacles that are outside of the field of vision of the rider, or are further away than the rider can see. In some variations, the object avoidance system 1400 can detect obstacles outside of the range of the light emitted lights 1302 of the powered skateboard.

When the powered skateboard is operated in light conditions, the object avoidance system 1400 can be deactivated. Deactivating the object avoidance system 1400 during operation of the powered skateboard during light conditions can extend battery life.

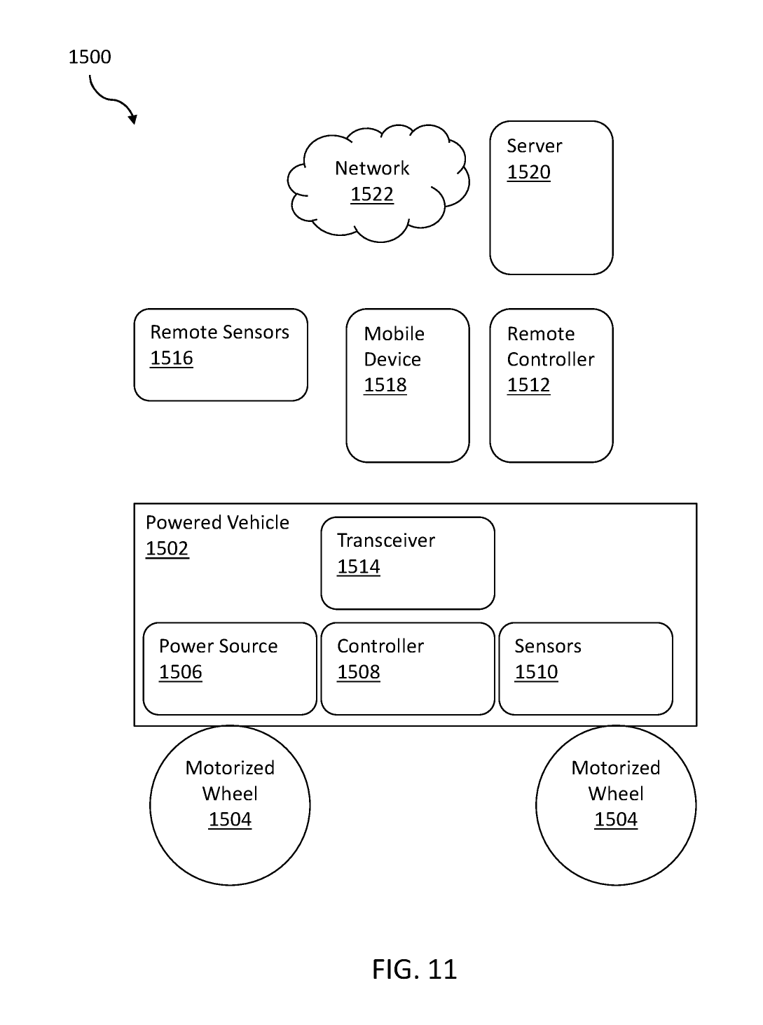

FIG. 11 is an illustration of a system 1500 having one or more features consistent with the present subject matter. The system 1500 can include a powered vehicle 1502. The powered vehicle 1502 can include one or more motorized wheels 1504. The one or more motorized wheels 1504 can be powered by a power source 1506 disposed in the powered vehicle 1502. A controller 1508 can be disposed within the powered vehicle 1502 and configured to deliver power from the power source 1506 to the motorized wheel 1504.

The controller 1508 can be configured to control the performance of the powered vehicle 1502 by modifying the amount of power delivered to the motorized wheel(s) 1504 and/or the speed at which the motorized wheel(s) 1504 rotate. The controller 1508 can be configured to modify the amount of power delivered to the motorized wheel(s) 1504 in response to one or more conditions detected by one or more sensors 1510 associated within the powered vehicle 1502. The controller 1508 can be configured to modify the operation of the powered vehicle 1502 in response to one or more commands received from a remote controller 1512. The one or more commands from the remote controller 1512 can be received through a transceiver 1514 associated within the powered vehicle 1502. The controller 1508 can be configured to modify the operation of the powered vehicle 1502 based on signals received from one or more remote sensors 1516. The signals from the remote sensor(s) 1516 can be received through the transceiver 1514.

The sensor(s) 1510, remote sensor(s) 1516, commands from the remote controller 1512, or the like, can be associated with events occurring within a virtual world. The virtual world can be hosted on one or more mobile devices 1518, on a server(s) 1520 in electronic communication with the mobile device(s) 1518, or the like. The mobile device(s) 1518 can communicate with the server(s) 1520 through a network 1522, such as the Internet.

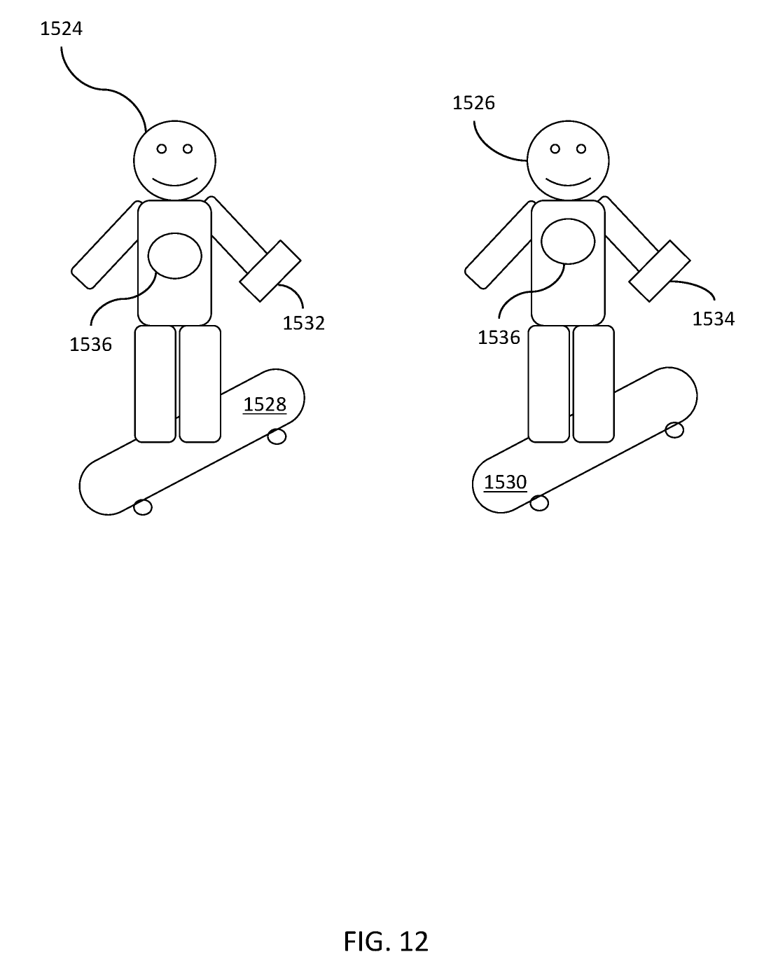

FIG. 12 is an illustration of a user 1524 and a user 1526 interacting with each other. In some variations, the user(s) 1524 and 1526 can interact with a virtual world while using powered vehicles 1528 and 1530. The user 1524 may interact with the virtual world through a mobile device 1532 associated with the user. The user 1526 may interact with the virtual world through a mobile device 1534 associated with the user. The mobile devices 1532 and 1534 can be a remote controller, a mobile computing device, or the like. The user(s) 1524 and 1526 may interact with the virtual world through virtual reality goggles or glasses. The virtual reality goggles or glasses can be configured to augment reality such that one or more virtual objects can be superimposed on a view of the real world.

In some variations, user(s) 1524 and 1526 may wear one or more sensors 1536. The sensor(s) 1536. As an example, user(s) 1524 and 1526 may have a device, such as mobile device(s) 1532 and 1534 configured to “shoot” virtual projectiles toward each other. In some variations, the device for shooting projectiles can be a standalone device. The sensor(s) 1536 can be configured to detect a virtual projectile interacting with the sensor(s) 1536. In response to the sensor(s) 1536 detecting a hit, a signal can be transmitted to the controller 1508 on the powered vehicle 1528 or 1530 associated with the user that was hit. The controller 1508 can be configured to modify the operation of the powered vehicle 1528 or 1530 associated with the user 1524 or 1526 that was hit. For example, the controller 1508 can cause the powered vehicle to have reduce performance and/or speed for a period of time after the user associated with the powered vehicle has been hit.

The sensor(s) 1536 and the “shooting” devices can be configured to communicate using one or more wireless communication protocols. For example, via Bluetooth, infrared, Wi-Fi, Near-Field Communication, or the like. The sensor(s) 1536 can be configured to communicate with the controller 1508, through the transceiver 1514 and/or the mobile device(s) 1532 and 1534.

In some variations, the sensor(s) 1536 can be disposed in different locations. The performance of the powered vehicle can be modified differently based on which sensor is hit by the virtual projectile. For example, when a sensor on an arm of a user is hit, the performance of the powered vehicle may be affected less than when a sensor on the chest or head of the user is hit.

When interacting with a virtual world, virtual fences can be erected causing the powered vehicle(s) to change behavior at the virtual fence. For example, the powered vehicle may stop when it reaches the virtual fence, reduce speed, or provide a warning to the user of the powered vehicle that they have passed a virtual fence. Users of the powered vehicles can modify a real-world environment into a game or virtual environment to create virtual walls, tunnels, traps, hazards, and opponents.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. An electrically powered vehicle, comprising:
one or more electrical motors configured to provide motive force for the electrically powered vehicle;
a battery configured to provide electrical power to the one or more electric motors;
a sensor; and
a controller, in electronic communication with the sensor, configured to control, based on data received from the sensor, the one or more electrical motors.

2. The electrically powered vehicle of claim 1, wherein the sensor comprises a motion sensor configured to determine an orientation of the electrically powered vehicle, wherein the controller is further configured to adjust, in response to the sensor determining the orientation, a center of mass of the electrically powered vehicle.

3. The electrically powered vehicle of claim 1, wherein the sensor comprises a motion sensor configured to determine an angle of the electrically powered vehicle, wherein the controller is further configured to adjust, in response to the angle satisfying a threshold, an amount of electrical power delivered to the one or more electrical motors, a speed of the one or more electrical motors, and/or a direction of rotation of the one or more electrical motors.

4. The electrically powered vehicle of claim 1, further comprising a camera, wherein the sensor comprises a motion sensor configured to detect an acceleration of the electrically powered vehicle, wherein the camera is configured to obtain, in response to the sensor detecting the acceleration, a still and/or a video image.

5. The electrically powered vehicle of claim 1, wherein the sensor is configured to detect an object in a path of the electrically powered vehicle.

6. The electrically powered vehicle of claim 5, wherein the controller is further configured to adjust, in response to the sensor detecting the object, an amount of electrical power delivered to the one or more electrical motors, a speed of the one or more electrical motors, and/or a direction of rotation of the one or more electrical motors.

7. The electrically powered vehicle of claim 5, further comprising an electromagnetic wave source configured to emit electromagnetic waves, wherein the sensor is further configured to detect the object based on the emitted electromagnetic waves.

8. The electrically powered vehicle of claim 5, wherein the sensor comprises a camera configured to detect the object based on an image captured by the camera.

9. The electrically powered vehicle of claim 5, wherein the controller is further configured to provide, in response to the sensor detecting the object, haptic feedback and/or a notification to a user of the electrically powered vehicle.

10. The electrically powered vehicle of claim 1, wherein the controller is further configured to adjust, in response to data received from an external sensor, an amount of electrical power delivered to the one or more electrical motors, a speed of the one or more electrical motors, and/or a direction of rotation of the one or more electrical motors, the external sensor associated with a user of the electrically powered vehicle.

11. A method for powering an electrically powered vehicle, comprising:
providing motive force, by one or more electric motors, for the electrically powered vehicle; and
controlling, in response information received from a sensor of the electrically powered vehicle, a delivery of electricity to the one or more electric motor.

12. The method of claim 11, wherein controlling the delivery of electricity comprises adjusting an amount of power delivered to the one or more electrical motors, a speed of the one or more electrical motors, and/or a direction of rotation of the one or more electrical motors.

13. The method of claim 11, further comprising determining an orientation of the electrically powered vehicle, wherein controlling the delivery of electricity comprises adjusting, in response to the determining, a center of mass of the electrically powered vehicle.

14. The method of claim 11, further comprising determining an angle of the electrically powered vehicle, wherein controlling the delivery of electricity comprises adjusting, in response to the angle satisfying a threshold, an amount of power delivered to the one or more electrical motors, a speed of the one or more electrical motors, and/or a direction of rotation of the one or more electrical motors.

15. The method of claim 11, further comprising:
detecting an acceleration of the electrically powered vehicle; and
obtaining, in response to detecting the acceleration, a still and/or a video image.

16. The method of claim 11, further comprising detecting an object in a path of the electrically powered vehicle.

17. The method of claim 16, further comprising adjusting, in response to the detecting, an amount of power delivered to the one or more electrical motors, a speed of the one or more electrical motors, and/or a direction of rotation of the one or more electrical motors.

18. The method of claim 16, further comprising emitting electromagnetic waves, wherein the detecting is based on the emitted electromagnetic waves.

19. The method of claim 16, further comprising providing, in response to the detecting, haptic feedback and/or a notification to a user of the electrically powered vehicle.

20. The method of claim 11, further comprising adjusting, in response to data received from an external sensor, an amount of power delivered to the one or more electrical motors, a speed of the one or more electrical motors, and/or a direction of rotation of the one or more electrical motors, the external sensor associated with a user of the electrically powered vehicle.
